(19) United States
(12) Patent Application Publication
(10) Pub. No.: US 2009/0283987 A1
(43) Pub. Date: Nov. 19, 2009

(54) SYSTEM AND DEVICE FOR TRANSPORTING A WHEELED GARBAGE CAN

(76) Inventors: BRIAN LONG, Calhoun, GA (US); Pam Long, Calhoun, GA (US)

Correspondence Address: Innovative IP, LLC, P.O. Box 217, New Smyrna Beach, FL, 32170, US

(21) Appl. No.: 12/121,182

(22) Filed: May 15, 2008

(51) Int. Cl. B60D 1/50

(52) U.S. Cl. 280/498

(57) ABSTRACT

A system for transporting a wheeled container via a connector device linking the wheeled container to a hitch-adapted vehicle, wherein the connector device is adapted on a first end to receive and support the handle of a wheeled container, is adapted on a second end to attach to a hitch ball, and is configured therebetween to efficiently transfer forces.

### FIELD OF THE INVENTION

The present invention relates generally to refuse receptacles, and more particularly, to a system and device for transporting a wheeled garbage can, wherein pivotable and slidable support hooks easily secure to and support essentially any can, wherein a quick-release clamp facilitates easy attachment to essentially any vehicle hitch, and wherein a sturdy L-shaped connector serves as a link between the can and the vehicle, thereby enabling transport of a wheeled garbage can behind a selected vehicle.

### BACKGROUND OF THE INVENTION

Garbage pickup is available to many, if not most, American homes. Such pickup enables the homeowner to dispose of refuse without having to self-transport to a garbage dump or other such facility. Instead, homeowners simply collect their garbage for pickup, typically once a week. Garbage collectors travel a set collection path, picking up garbage for transport to an incinerator, for example. Early garbage collectors would venture from their vehicle with wheeled collection bins, entering a homeowner's property to collect garbage from the homeowner's cans, and then returning to the garbage collection truck to empty the collection bin, repeating this effort at each home.

As municipalities grew and the need to serve more homes increased, garbage service providers, no longer willing or able to enter a homeowner's property to empty cans, began requiring homeowners to transport their own garbage to the curb for pickup. As homeowner's began facing the regular task of garbage transport, receptacles were adapted with wheels to facilitate such movement, in order to eliminate the need to lift and carry the heavy loads. At the same time, garbage collection vehicles were adapted for increased efficiency and ease of use, wherein most service providers eventually incorporated garbage collection trucks specially adapted to receive, engage, and empty specially designed garbage cans. While each truck/can system is generally unique, resulting in a continued variety of garbage cans, all of the cans are commonly designed to hold a maximum volume of garbage, while at the same time remaining generally transportable to the curb by the homeowner. That is, exterior dimensions, handle shapes, and the like, are varied according to the requirements of the trucks of the garbage service provider, but general characteristics remain, such that each can is adapted to be transported to the curb by grasping of a handle, tilting of the can, and pulling on wheels.

It is true that the foregoing systems have increased garbage collection efficiency, and have generally redefined and standardized garbage pickup procedures. Unfortunately, however, while the oversized cans are convenient for the efficacy of the collection process, the weight of such filled cans can prevent some homeowners from being able to transport the cans to the curb safely, and without injury or strain. Additionally, some driveways may be steeply inclined, rendering the transport job even more difficult. And, for individuals property owners with larger tracts of land, such as those living in subdivisions with acre-plus homesites, transport of the garbage to the curbside may require traversing hundreds of feet or more.

As a result, some devices have been proposed to allow for the transport of a garbage can by a household vehicle. Each such device, however, is disadvantageous in view of the present invention. Some inconveniently require a homeowner utilize tools, nuts and bolts to attach and detach the transport device to a vehicle for each use, and/or require a chain or strap to be time-consumingly fed through and secured about the can handle for each transport. Others are inherently limited according to the types of vehicles that may be utilized for pulling. Still others involve complex lifting and/or attachment mechanisms, with most only able to accommodate particular can and/or handle dimensions in order to function.

Therefore, it is readily apparent that there is a need for a system and device for transporting a wheeled garbage can, wherein quick and easy connection to virtually any can is facilitated, and wherein quick and easy connection to virtually any hitch is also facilitated, thereby avoiding the above-discussed disadvantages.

### BRIEF SUMMARY OF THE INVENTION

Briefly described, in a preferred embodiment, the present invention overcomes the above-mentioned disadvantages and meets the recognized need for such a device by providing a system and device for transporting a wheeled garbage can, wherein a homeowner can essentially hang the device on the handle of an upright garbage can during non-use, wherein a homeowner can attach the device to the hitch on any vehicle without the use of tools and without requiring removal of any parts, and wherein a homeowner can selectively pivot and/or slide device components to receive, accommodate and support the handle of a tilted, wheeled garbage can for transport.

According to its major aspects and broadly stated, in its preferred form, the present invention is a system for transporting a wheeled container via a connector device linking the wheeled container to a hitch-adapted vehicle, wherein the connector device is adapted on a first end to receive and support the handle of a wheeled container, is adapted on a second end to attach to a hitch ball, and is configured therebetween to efficiently transfer forces.

More specifically, the device of the present invention in its preferred form is a system and device for transporting a wheeled garbage can comprising a can support end, a vehicle mount end, and an L-shaped frame therebetween. According to the preferred configuration, the can support end has two hooks pivotally and slidably supported in a manner that permits rotational movement for easy placement for engagement about a portion of the periphery of a can handle, and that further permits slidable movement for adaptive accommodation to dimensional limitations of can handle widths. The vehicle mount end has a hatch-style lever to facilitate easy lock-down of the vehicle mount end onto a tow hitch, and for quick release and removal after use. The compression fit of the vehicle mount end relative to the hitch enables utilization of the device on any of a plurality of hitches on essentially any vehicle, wherein essentially any wheeled trash receptacle may be transported by homeowner vehicles, such as, for exemplary purposes only, all-terrain vehicles, riding mowers, tractors, golf carts, lawn mowers, cars, trucks, sport-utility vehicles, or any other suitable vehicle.

Thus, a feature and advantage of the present invention is its ability to be utilized to transport essentially any wheeled garbage can.

Another feature and advantage of the present invention is its ability to offer a new manner for transporting refuse to a curbside location for pickup, wherein essentially any household vehicle may be utilized for same.

Still another feature and advantage of the present invention is its ability to eliminate homeowner effort and strain from the process of relocating containerized waste for pickup.

Yet another feature and advantage of the present invention is its ability to provide a device for transporting a wheeled garbage can with a simple and effective operational concept and mechanical structure.

Still yet another feature and advantage of the present invention is its ability to wheeled garbage can transport device that can be quickly and easily secured between a vehicle and a wheeled garbage can, and/or removed therefrom, without the need for tools.

Still yet another feature and advantage of the present invention is its ability to facilitate essentially identical transport results for essentially any wheeled garbage can with a handle.

Yet still another feature and advantage of the present invention is its ability to provide for safe use via elimination of physical strain from individual transport.

Yet another feature and advantage of the present invention is its ability to provide a wheeled garbage can transport device with increased adaptability to a plurality of can structural designs, and with maximized ease of use.

Still yet another feature and advantage of the present invention is its ability to facilitate support and pulling of tilted wheeled cans.

Yet still another feature and advantage of the present invention is its ability to adapt to a plurality of hitch surface dimensions.

These and other objects, features and advantages of the present invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1 is a side view of a transport device, according to the preferred embodiment of the present invention;

FIG. 2 is a side, perspective view of the transport device of FIG. 1, showing the device supporting a tilted garbage can while attached to the hitch of a personal utility vehicle;

FIG. 3 is a widened view of the transport device as shown in FIG. 2, showing a full exemplary view of the device being utilized to transport a garbage can via an exemplary personal utility vehicle;

FIG. 4 is a side, perspective view of the transport device of FIG. 1, showing the device supporting a tilted garbage can while attached to the hitch of a riding lawn mower;

FIG. 5 is a widened view of the transport device as shown in FIG. 4, showing a full exemplary view of the device being utilized to transport a garbage can via an exemplary riding lawn mower; and

FIG. 6 is a side view of the transport device of FIG. 1, showing the device supporting a tilted garbage can while attached to the hitch of an exemplary pick-up truck.

### DETAILED DESCRIPTION OF THE PREFERRED AND ALTERNATE EMBODIMENTS

In describing the preferred and alternate embodiments of the present invention, as illustrated in the figures and/or described herein, specific terminology is employed for the sake of clarity. The invention, however, is not intended to be limited to the specific terminology so selected, and it is to be understood that each specific element includes all technical equivalents that operate in a similar manner to accomplish similar functions.

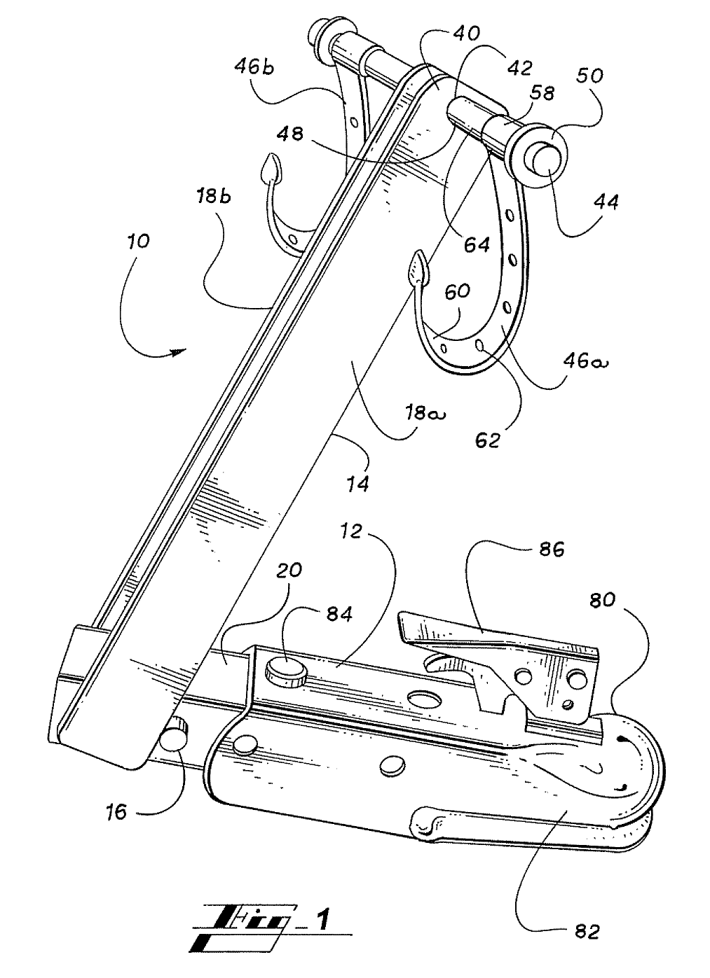

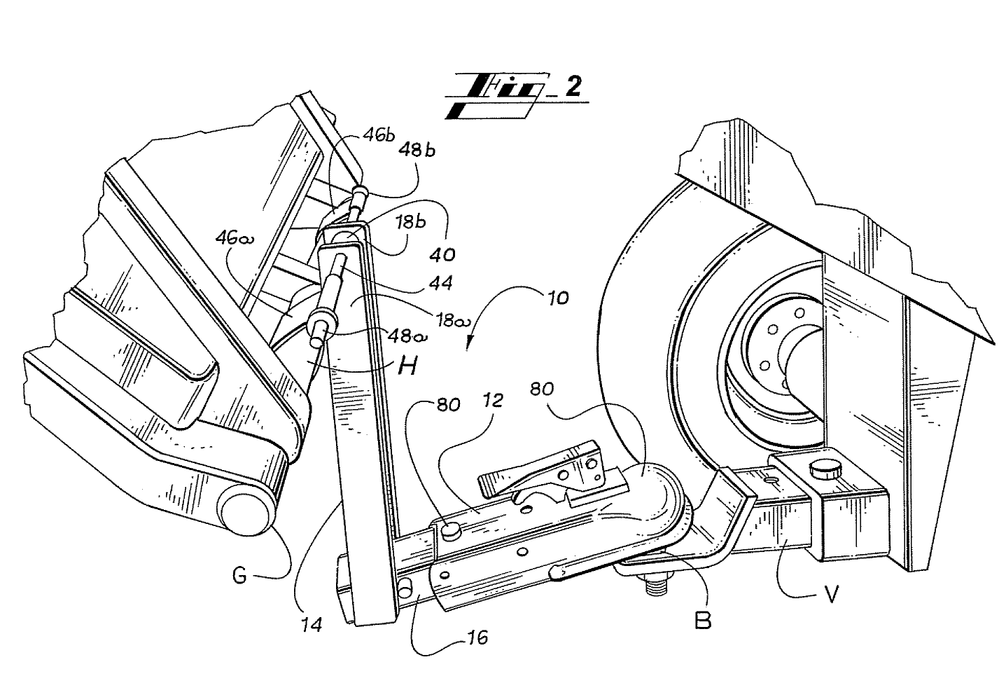

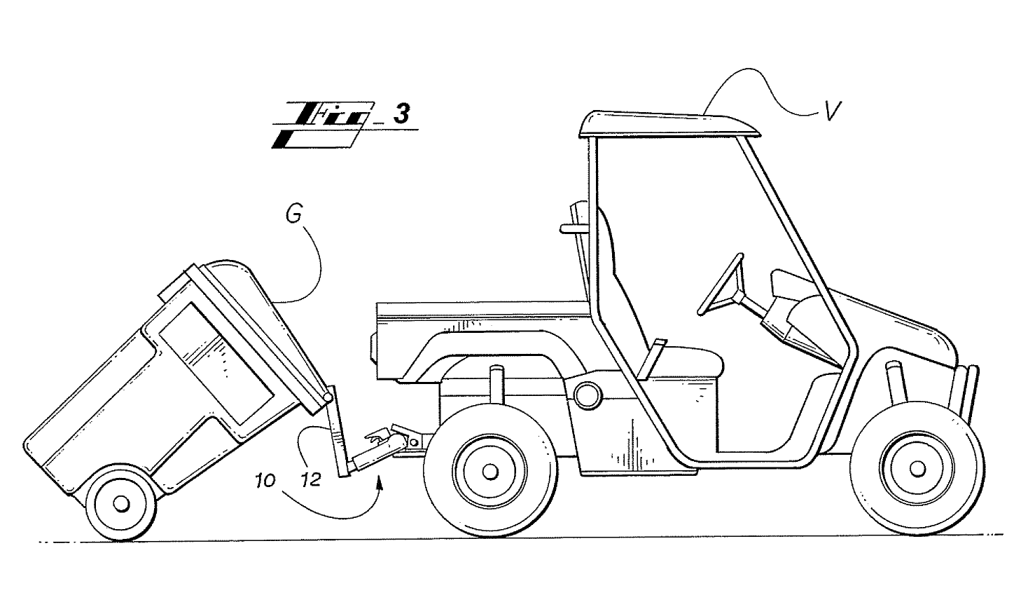

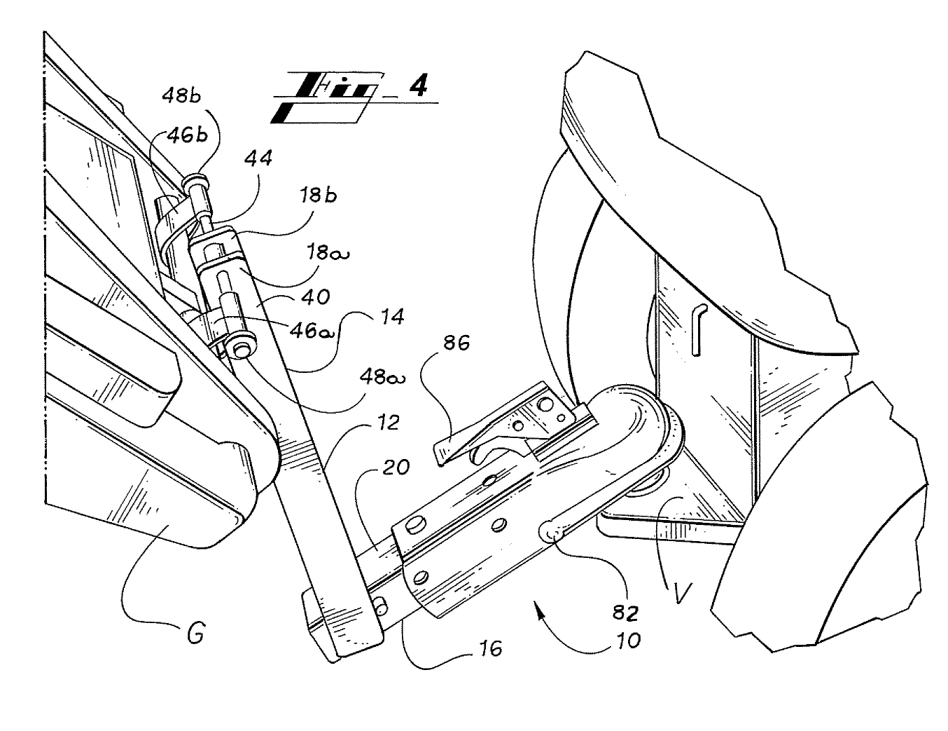

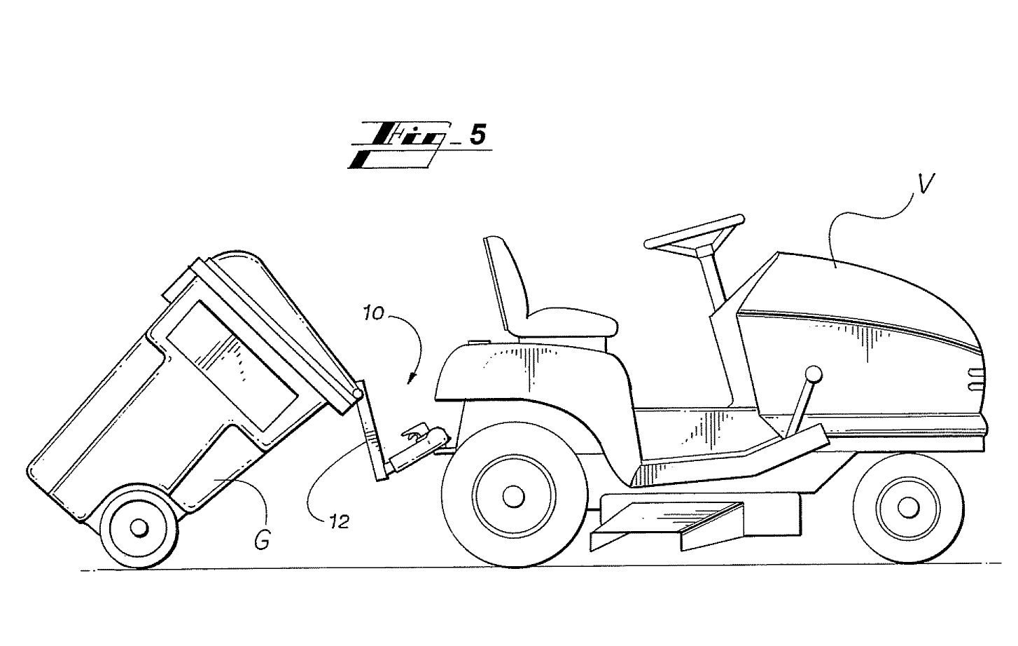

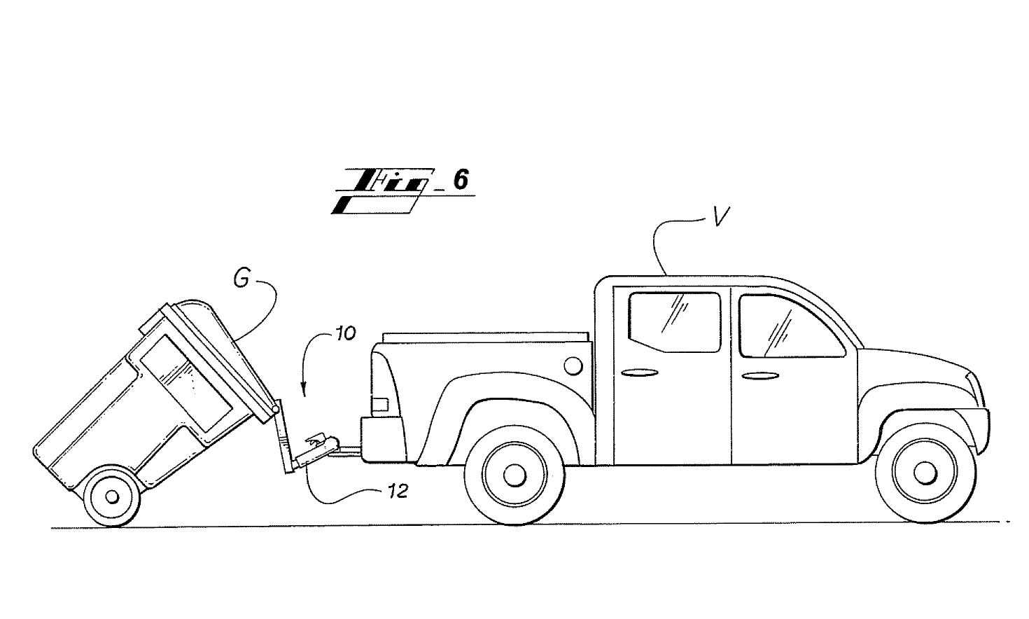

Referring now to FIGS. 1-6, the present invention, in the preferred embodiment, is system and device 10 for transporting a wheeled garbage can, wherein connector 12 links wheeled container G to hitch-adapted vehicle V, wherein first end 40 of connector 12 is adapted to receive and support handle H of wheeled container C, and wherein second end 80 of connector 12 is adapted to attach to hitch ball B.

According to the preferred embodiment, device 10 is produced from hardened steel for strength and durability. One skilled in the art would readily recognize, however, that any suitably strong and appropriately enduring materials could alternately be utilized without departing from the present invention. Preferably, connector 12 is defined by first arm 14 and second arm 16, linked in a generally L-shaped configuration. Although it is preferred that first arm 14 and second arm 16 are welded in a predefined arrangement relative to one another as shown, first arm 14 and second arm 16 could alternately be integrally formed, or could be pivotally related, such as with a selectable locking mechanism, slidable pin, resilient catch button, or the like.

In order to accommodate such preferred and alternate arrangements, first arm 14 is preferably formed from pair of opposing planar members 18a, 18b, while second arm 16 is preferably formed from unitary member 20, preferably a hollow prism-shaped member. Accordingly, opposing planar members 18a, 18b preferably define a width therebetween that is sufficient to accommodate unitary member 20, such that each planar member 18a and 18b may be preferably welded to the outer surface of unitary member 20. Although it is preferred that second arm 16 of connector 12 is hollow in order to reduce overall weight of device 10, one skilled in the art would readily recognize that second arm 16 could alternately be solid, or otherwise non-hollow. Further, second arm 16 could alternately define a U-shaped profile, rather than an overall prism shape.

Aperture 42 is preferably defined through first end 40 of connector 12, that is, through planar members 18a and 18b, wherein crossbar 44 extends therethrough. Crossbar 44 is preferably fixed positionally relative to first end 40 of connector 12; however, each hook 46a, 46b is swivelably installed on crossbar 44 in order to facilitate rotational movement about crossbar 44, and each hook 46a, 46b is also slidably installed on crossbar 44 in order to facilitate smoothly adjustable and selectable positioning along the length of crossbar 44. This enables adaptability to essentially any can handle design, irrespective of handle support positioning. Also preferably, each end 48a, 48b of crossbar 44 has a structural stop 50, whereby passage of each hook 46a, 46b is hindered thereby. Structural stop 50 is preferably a lock nut or other such suitable component member.

Each hook 46a, 46b is preferably formed with ringed-mount end 58 having mount aperture 50 defined therethrough in order that each hook 46a, 46b may be mounted onto crossbar 44 in a manner to facilitate rotational movement. Preferably, each hook 46a, 46b is free to rotate completely around crossbar 44 in order to allow for maximized adaptability of device 10; however, in other embodiments, hooks 46a, 46b could be mounted in such manner as to have a limitation to the permitted angle of rotation or swing.

Horseshoe end 60 of each hook 46a, 46b is preferably flat and of generally smooth surface proximate interior region 62 in order to avoid damage or wear to a handle H of a garbage can G. The preferred traditional hook shape of hooks 46a, 46b facilitates easy engagement with a handle H and avoids the necessity for encircling same in order to effectively pull can G. Moreover, during periods of non-use, the beneficially-shaped hooks 46a, 46b and the pivotal attachment, together enable hanging storage of device 10 on the handle H of a garbage can G for convenient access when can transport is desired, yet without hindering deposit of garbage into the can G.

Second end 80 of connector 12 is preferably equipped with hitch connector 82, wherein hitch connector 82 is preferably securely bolted to second arm 16 of connector 12 at bolt 84. It is intended to be within the scope of the present invention that alternate means of attachment for hitch connector 82 could be utilized. For example, hitch connector 82 could be integrally formed with second arm 16, could be welded to second arm 16, or could otherwise be fastened according to any appropriate means.

Hitch connector 82 is preferably of known configuration to receive a ball hitch, and preferably with quick-release hitch lever 86. While other hitch connectors could be utilized, the preferred hitch connector 82 advantageously enables quick connection and removal without necessitating the use of tools. This feature of the present invention is particularly beneficial given the inherent short-term, frequent-repeat use of device 10. Moreover, the ability of hitch connector 82 to attach to essentially any ball hitch advantageously enables device 10 to be mounted to the rear of essentially any vehicle, such as, for exemplary purposes only, all-terrain vehicle, riding mower, tractor, golf cart, lawnmower, car, truck, or SUV. The pivotal arrangement of hooks 46a, 46b further facilitates the adaptation of device 10 to said variety of vehicles by enabling automatic adjustment to height variations therebetween.

In an alternate embodiment, hitch connector 82 could be configured to seat within a female hitch receiving port with an appropriate on-board locking mechanism, such as a slidable pin or frictional tab.

In the preferred use for device 10, hitch connector 82 is attached to a hitch ball and secured thereto via lever 86. Garbage can G is positioned and tilted until handle H is resting in hooks 46a, 46b. Garbage can G is then ready for transport. Alternately, hooks 46a, 46b could be engaged with handle H first, wherein attachment of hitch connector 82 to a vehicle could be accomplished thereafter.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

We claim:

1. A device for transporting a wheeled garbage can, comprising:
an L-shaped support member;
a hitch connector carried by a first end of said L-shaped support member; and
a can connector carried by a second end of said L-shaped support member, said can connector further comprising a plurality of pivotally mounted hooks.

2. The device of claim 1, wherein each of said plurality of pivotally mounted hooks is slidably carried on a cross-bar.

3. The device of claim 2, wherein said cross-bar is positioned at a right angle relative to the length of said L-shaped member.

4. The device of claim 1, wherein said hitch connector further comprises a quick-release clamp.

5. The device of claim 1, wherein said hitch connector is configured to receive a hitch ball.

6. The device of claim 1, wherein said hitch connector is configured to mate within a female hitch receptacle.

7. The device of claim 1, wherein said device is manufactured from hardened steel.

8. The device of claim 1, wherein said L-shaped connector is comprised of a first arm and a second arm.

9. The device of claim 8, wherein said first arm and said second arm are welded together.

10. The device of claim 8, wherein said first arm and said second arm are bolted together.

11. The device of claim 8, wherein said first arm and said second arm are integrally formed.

12. The device of claim 8, wherein said first arm and said second arm are pivotally related.

13. The device of claim 8, wherein said first arm is formed from pair of opposing planar members and said second arm is formed from a unitary hollow member.

14. The device of claim 13, wherein said second arm is prism-shaped.

15. The device of claim 2, wherein said cross-bar extends through an aperture in said first arm.

16. The device of claim 2, further comprising a plurality of structural stops carried by said cross-bar, proximate a first end and a second end thereof.

17. The device of claim 2, wherein rotational movement of said hooks about the circumference of said cross-bar is enabled.

18. A system for pulling a wheeled waste receptacle behind a vehicle, comprising:
a quick-release hitch mount;
a pair of hook-shaped pivots; and
a support member connected therebetween,
wherein each of said pair of hook-shaped pivots is independently slidable along the length of a hook support bar, and wherein each end of said hook support bar carries a stop that prevents slidable removal of said hook-shaped pivots from said hook support bar.
